(19) United States
(12) Patent Application Publication
(10) Pub. No.: US 2012/0162046 A1
(43) Pub. Date: Jun. 28, 2012

(54) ANTENNA ASSEMBLY

(75) Inventors: WEN-HSIANG HUNG, Tu-Cheng (TW); CHUN-BAO GU, Shenzhen City (CN); WEI-WEI ZHU, Shenzhen City (CN); XIAO-HUI YU, Shenzhen City (CN)

(73) Assignees: HON HAI PRECISION INDUSTRY CO., LTD., Tu-Cheng (TW); HONG FU JIN PRECISION INDUSTRY (ShenZhen) CO., LTD, Shenzhen City (CN)

(21) Appl. No.: 12/982,914

(22) Filed: Dec. 31, 2010

(30) Foreign Application Priority Data
Dec. 25, 2010 (CN) 201010606806.7

(51) Int. Cl. H01Q 1/24

(52) U.S. Cl. 343/892

(57) ABSTRACT

A antenna assembly includes a mounting plate defining a number of through holes, and an antenna. The antenna includes a mounting piece and a signal portion extending from the mounting piece. The mounting piece includes two spaced first latching portions at a top and a second latching portion at a bottom. The first and second latching portions are locked to the corresponding through holes.

### BACKGROUND

1. Technical Field

The disclosure relates to an antenna assembly.

2. Description of Related Art

An antenna is usually mounted to an enclosure of a desktop computer by a plurality of screws. A screwdriver is usually used to assemble or disassemble the screws. It is inconvenient and time-consuming to operate the screws with the screwdriver.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, all the views are schematic, and like reference numerals designate corresponding parts throughout the several views.

FIG. 1 is an exploded, isometric view of an exemplary embodiment of an antenna assembly, the antenna assembly includes a mounting plate, an antenna, and an attaching member.

FIG. 2 is an enlarged view of the antenna of FIG. 1, but viewed from another perspective.

FIG. 3 is an assembled, isometric view of the antenna and the mounting plate of FIG. 1.

FIG. 4 is an assembled, isometric view of FIG. 1.

### DETAILED DESCRIPTION

The disclosure, including the accompanying drawings, is illustrated by way of examples and not by way of limitation. It should be noted that references to “an” or “one” embodiment in this disclosure are not necessarily to the same embodiment, and such references mean at least one.

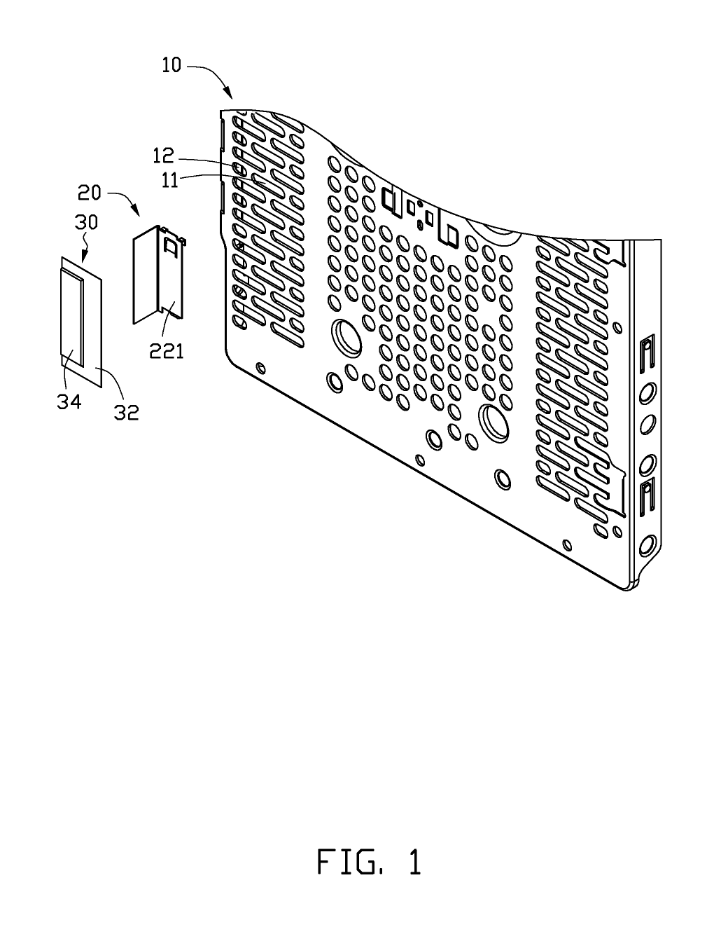

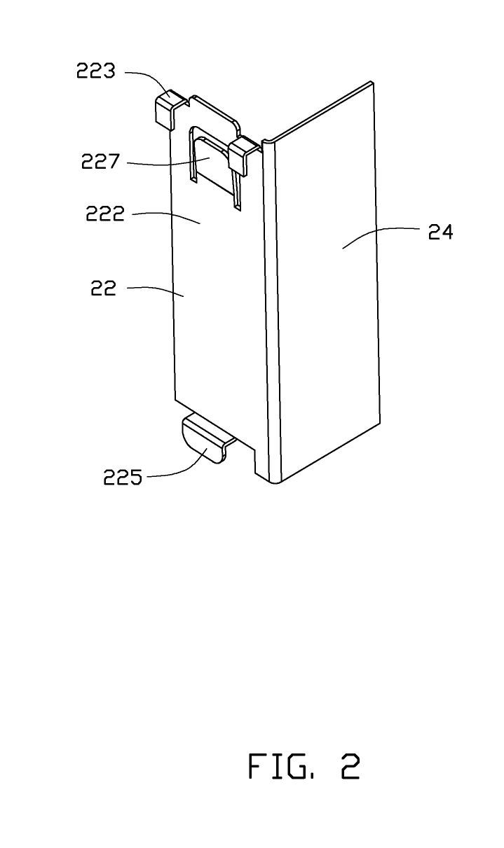

Referring to FIGS. 1 and 2, an exemplary embodiment of an antenna assembly includes a mounting plate 10, an antenna 20, and an attaching member 30.

The mounting plate 10 defines a plurality of through holes 11 and 12. In this embodiment, the mounting plate 10 may be a sidewall of an enclosure of a desktop computer (not shown) or a metal plate mounted in the enclosure of the desktop computer. The through holes 11 and 12 are vents for heat dissipation.

The antenna 20 includes a mounting piece 22, and a signal portion 24 substantially perpendicularly extending from a side of the mounting piece 22 and facing a first surface 221 of the mounting piece 22 for sending or receiving electromagnetic waves. Two spaced substantially L-shaped first latching portions 223 extend toward a second surface 222 of the mounting piece 22 from a top of the mounting piece 22. A substantially L-shaped second latching portion 225 extends toward the second surface 222 of the mounting piece 22 from a bottom of the mounting piece 22. A resilient portion 227 extends from the mounting piece 22 adjacent to the first latching portions 223.

The attaching member 30 is substantially rectangular and includes an attaching portion 32 and a receiving portion 34. In this embodiment, the attaching member 30 may be an aluminum foil.

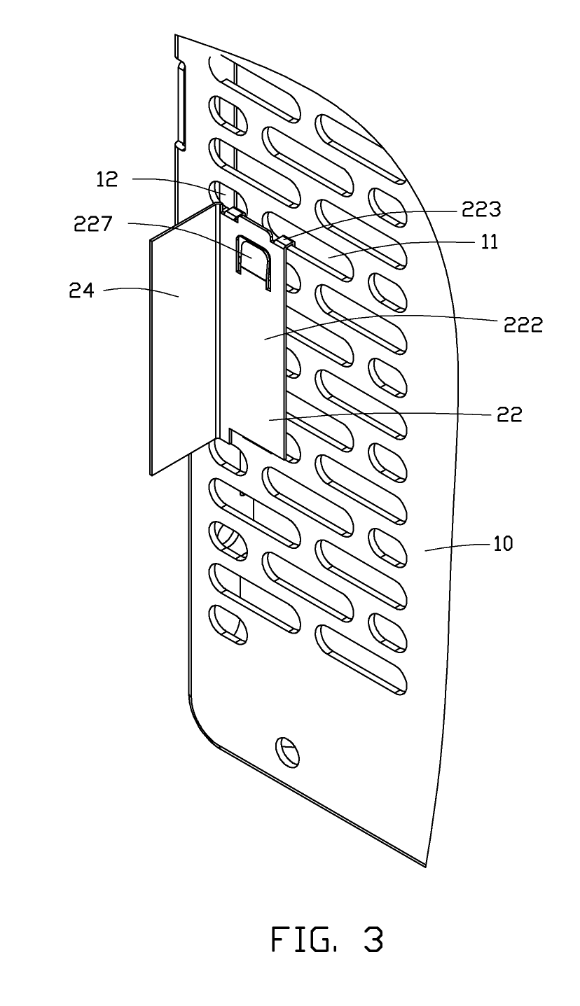

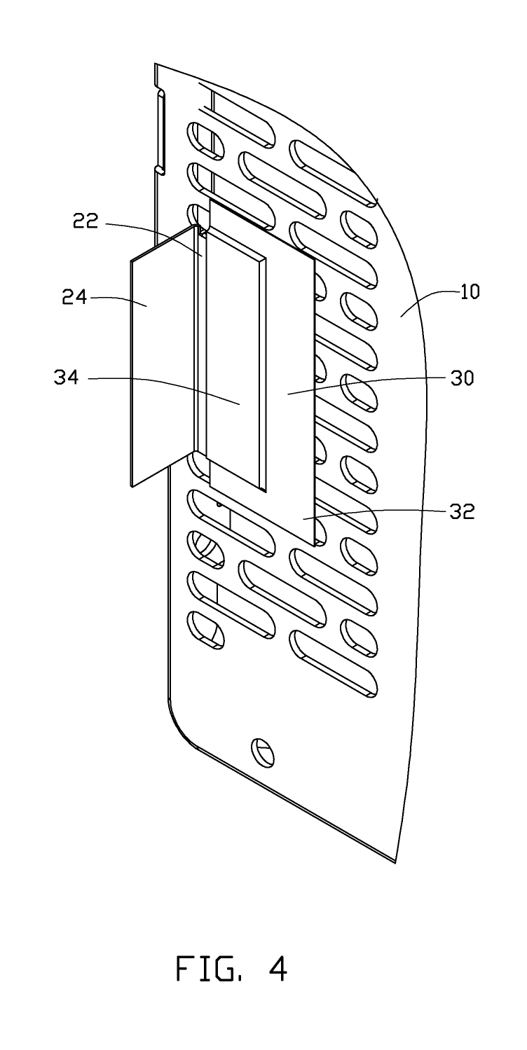

Referring to FIGS. 3 and 4, in assembly, the first latching portions 223 of the antenna 20 are locked to two adjacent through holes 11 and 12 of the mounting plate 10. The second latching portion 225 is locked to another through hole 11 or 12 of the mounting plate 10. The resilient portion 227 resists against the mounting plate 10. The attaching portion 32 of the attaching member 30 is attached to the mounting plate 10. The receiving portion 34 of the attaching member 30 receives the mounting piece 22 of the antenna 20 to press the mounting piece 22 firmly against the mounting plate 10. In this embodiment, glue may be used to adhere the attaching portion 32 of the attaching member 30 to the mounting plate 10.

In this disclosure, the first latching portions 223 and the second latching portion 225 are used to latch the antenna 20 to the mounting plate 10 of the enclosure of the desktop computer, without using screws.

It is to be understood, however, that even though numerous characteristics and advantages of certain embodiments have been set forth in the foregoing description, together with details of the structures and functions of the embodiments, the disclosure is illustrative only, and changes may be made in detail, especially in matters of shape, size, and arrangement of parts within the principles of the disclosure to the full extent indicated by the broad general meaning of the terms in which the appended claims are expressed.

What is claimed is:

1. An antenna assembly comprising:
a mounting plate defining a plurality of through holes; and
an antenna comprising a mounting piece and a signal portion extending from the mounting piece, the mounting piece comprising two spaced first latching portions at a top and a second latching portion at a bottom;
wherein the first and second latching portions are locked to the through holes respectively.

2. The antenna assembly of claim 1, wherein the first and second latching portions are substantially L-shaped.

3. The antenna assembly of claim 1, wherein a resilient portion extends from the mounting piece of the antenna to resist against the mounting plate.

4. The antenna assembly of claim 1, further comprising an attaching member sandwiching the mounting piece of the antenna together with the mounting plate.

5. The antenna assembly of claim 4, wherein the attaching member comprises a receiving portion for receiving the mounting piece, and an attaching portion adhered to the mounting plate.

6. The antenna assembly of claim 4, wherein the attaching member is aluminum foil.

7. The antenna assembly of claim 1, wherein the through holes of the mounting plate are vents for heat dissipation.
